(19) United States
(12) Patent Application Publication
(10) Pub. No.: US 2010/0308137 A1
(43) Pub. Date: Dec. 9, 2010

(54) Food dispenser with a vacuum system

(76) Inventor: Ryan T. Watkins, Ballston Spa, NY (US)

Correspondence Address: Law Office of Gerow Brill, 20 Oakmont Circle, New Freedom, PA, 17349, US

(21) Appl. No.: 11/810,335

(22) Filed: Jun. 5, 2007

Related U.S. Application Data
(60) Provisional application No. 60/810,984, filed on Jun. 5, 2006.

(51) Int. Cl. B02C 17/00; B02C 23/00; B67D 7/06

(52) U.S. Cl. 241/24.16; 222/1; 222/144; 241/100; 222/144.5

(57) ABSTRACT

A first, exemplary embodiment has a first container (spice rack) to organize and house the spices. On the outside of this container, there is a plurality of buttons with each button corresponding to each spice in a plurality of second containers (spice container) mounted on a Lazy Susan device. When a button is pushed, the appropriate spice will come out of the selected second container. Each button corresponds to a barcode. Each spice container will have a barcode on it representing the spice within the spice container and a scanner on the inside of the first container will scan each barcode until it comes to the barcode that corresponds to the button hit.

### CROSS REFERENCE

This application is related to provisional application 60/810,984filed on Jun. 5, 2006 entitled Food Rack with a vacuum system.

### FIELD OF INVENTION

The present invention relates to the field of food storage technology.

### BACKGROUND OF THE INVENTION

The present invention relates to the field of food storage technology. More particularly, the present invention relates to vacuum appliances for consumer and industrial applications along with improved organization within the storage device.

Consumer products involving vacuuming and sealing plastic bags have grown in popularity over the years. The basic model available includes a seal wire which seals the length of the bag and a vacuum pump which pumps air out of the bag prior to sealing. This model works well enough to have sold and inspired imitation.

Unfortunately, the model described provides vacuum capability only for plastic bags. Some food and similar material is typically better stored in drawers or rigid containers. Drawers are not obviously suitable for use with a vacuum. Providing a sealed environment in which a component may slide in and out may be a challenge. However, rigid containers provide a simpler solution to storing food within a vacuum sealed environment.

In particular, adapting a spice rack or cabinet for use with vacuum sealing may be useful, as spices for example are likely to be used in small quantities at varying and often long intervals. Purchasing spices in small quantities tends to be expensive. Storing spices in significant quantities over long periods of time tends to result in the spices losing their potency or flavor, and thus defeats the purpose of purchasing the spices in sufficient quantities to either justify long-term storage or provide for significant discounts. As such, a spice rack that allows for vacuum storage of spices may be useful.

### PROBLEM

### Preservation

The problem of preservation plagues all food products. With respect to ground food products, such as coffee and spices, the potency of the taste slowly diminishes over time. Refrigeration is often used to slow the decaying process of foods; however, it is not practical to store all food items in a refrigerator. Therefore alternative preservation techniques are necessary for products such as cooking spices and coffee which are not typically stored in a refrigerator.

Three factors attribute to problems with preservation
Light
   Causes fading
Humidity
   Water causes spices to decompose faster
Air
   Fuels the growth of insects and organisms inside spice containers
      What gives spice's their flavor?

All spices contain a chemical substance called terpenes (also known as essential oils).
These oils are what provide flavor and characteristics of the spice.
When these are lost, so is the potency of the taste, resulting in duller taste sensation.
   Typical life of spices, once opened

Ground Spices—1.5 years

Whole Spices—2 years

Green Leafy herbs—1-3 years

Whole seeds—3-4 years

Herb or Spice Extracts—3 years

Seasoning Blends—1.5 years

So they say it's a problem, but is it?

To find this out, a taste test was conducted.
This test was conducted by testing a total of 30 people.
Participants in the taste test were asked to taste test an assortment of spices (varying from freshly opened spices to year old spices). For each spice tested, the participant rated the potency of the flavor on a scale of one to ten.

Results
Difference between the old and new
   Cumin taste—1.25
   Cinnamon taste—1.35
   Black Pepper taste—0.35

What's out there?
All spice companies admit this is a problem, however little is done to counteract it
All spice containers are vacuumed when they are first packaged.
Some spice containers have a built in grinder.
All containers are air tight.

### Organization

The average household kitchen is haphazardly organized. Items are typically stored with respect to general characteristics of the item, such as storing pots and pans in the same cupboard or baking supplies in the same cabinet. However, no specific organization is used with respect to the specific location of each item within its general location. In particular, spices are typically stored in a spice rack; however, there exists no particular slot for each spice where to spice always resides. Therefore, while cooking, it can become tedious to find a particular spice among thirty of forty spices within the spice rack.

### SUMMARY OF THE INVENTION

A first, exemplary embodiment has a first container (spice rack) to organize and house the spices. On the outside of this container, there is a plurality of buttons with each button corresponding to each spice in a plurality of second containers (spice container) mounted on a revolving tray (Lazy Susan) device (or similar spice storage system). When a button is pushed, the appropriate spice will come out of the first container. Each button corresponds to a barcode. Each spice container will have a barcode on it representing the spice within the spice container and a scanner on the inside of the first container will scan each barcode until it comes to the barcode that corresponds to the button hit.

Once the second container is ready to be deposited back into the first container, it will be vacuum sealed. A device will be screwed onto the second container and vacuum seal the second container. The second container can then be placed back in the first container for storage.

These and other features, aspects, and advantages of the present invention will become better understood with regard to the following description, appended claim and accompanying drawing.

### BRIEF DESCRIPTION OF THE DRAWINGS

FIG. 1 illustrates a perspective view of a food dispenser with a vacuum sealing system;

FIG. 2 illustrates a front view of the food dispenser;

FIG. 3 illustrates a top view of the food dispenser;

FIG. 4 illustrates two views of an opened spice container used with the food dispenser;

FIG. 6 illustrates two views of a closed container used with food dispenser; and

FIG. 7 illustrates two detailed views of a closed spice container used with food dispenser.

### DETAILED DESCRIPTION OF THE INVENTION

According to a survey conducted of about 20 people, the average person has approximately 20-25 spices in their kitchen. This survey also showed that about 90% of people keep their spices in their cupboard.

Since the presence of oxygen is the main cause of the flavor loss, the use of a vacuum sealing system is a key element of the invention. Also, as discussed above, whole spices last longer and have a more potent taste when freshly ground. A container holding the spice may have a built in grinder.

An exemplary embodiment has a first container (spice rack) to organize and house the spices other foods. On the outside of this first container, there is a plurality of buttons with each button corresponding to a spice contained in a plurality of second containers (spice container) mounted on a motorized revolving tray (Lazy Susan) device (or similar spice storage system). When a button is pushed, the revolving tray (Lazy Susan) device will rotate to place the appropriate spice container so as to be removable from the first container. Each button corresponds to a specific barcode. Each spice container will have a barcode on it representing the spice within the spice container. A scanner on the inside of the first container will scan each barcode until it comes to the barcode that corresponds to the button hit.

Another embodiment may use voice recall to get to the contents of a spice jar. Cell phones now have a feature where one can say the name of the person one wants to call (and if it is in the phone book of the phone) it will call the number without the user having to look through all the numbers. Instead of having 50 buttons on the outside of the first container, there is a microphone where the user can say the name of the spice he/she wants. In turn, the barcode scanner would look for the spice the user spoke into the microphone.

To preserve the spices, a vacuum system is used to vacuum seal the spice containers. U.S. Pat. No. 7,003,928 ('928) issued to Patterson, et al. on Feb. 28, 2006, hereby incorporated by reference, describes a device that, when screwed onto a mason jar (canning jar), it will vacuum seal the jar. A similar system is described at http://www.kk.org/cooltools/archives/000288.php. The embodiment/system described herein is similar, but redesigned to fit spice containers within the first container described above.

One such embodiment comprises an internal a vacuum system and vacuum positioning system. Upon placing a spice container (second container) back into the first container, the user may activate a button to activate the vacuum system. This action positions the second container within the vacuum system so as to permit the vacuum system to create a vacuum within the second container. When the second container achieves a desired vacuum level, the dispensing system is able to retrieve the second container for use with the dispensing system.

In a manual version, after a user is done using a spice container or jar, he/she screws on the vacuum sealer and vacuum seals the jar using the external vacuum arm. The vacuum sealer includes a lid valve assembly similar to the canister lid valve assembly described column 13, line 7 through column 15, line 28 and FIGS. 15-17 of the ‘928 patent. As mentioned above the ‘928 patent is hereby incorporated by reference. The spice container is then placed back on the revolving tray (Lazy Susan) within the first container.

U.S. patent application Ser. No. 10/911,231 by Higer et al entitled “Vacuum Packaging Appliance Rack” filed Aug. 3, 2004 and published as U.S. 2005/0061370 A1 on Mar. 24, 2005, hereby incorporated by reference, instructs the vacuum sealing of drawers. The instant invention vacuum seals actual spice containers/jars and not drawers. The instant invention is less complicated and does not have to vacuum seal a spice rack. The instant invention can house more spices and is more space efficient. The spices are more easily accessible than the other design.

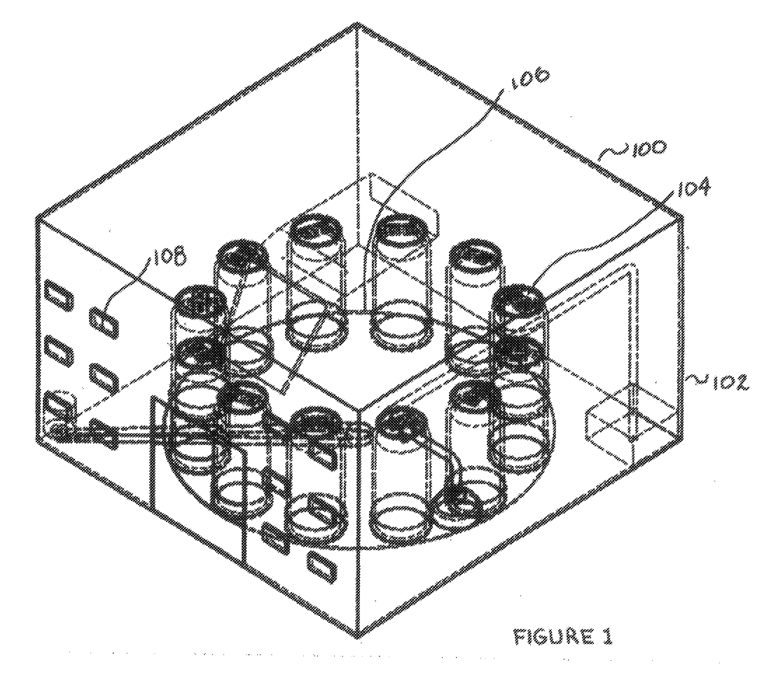

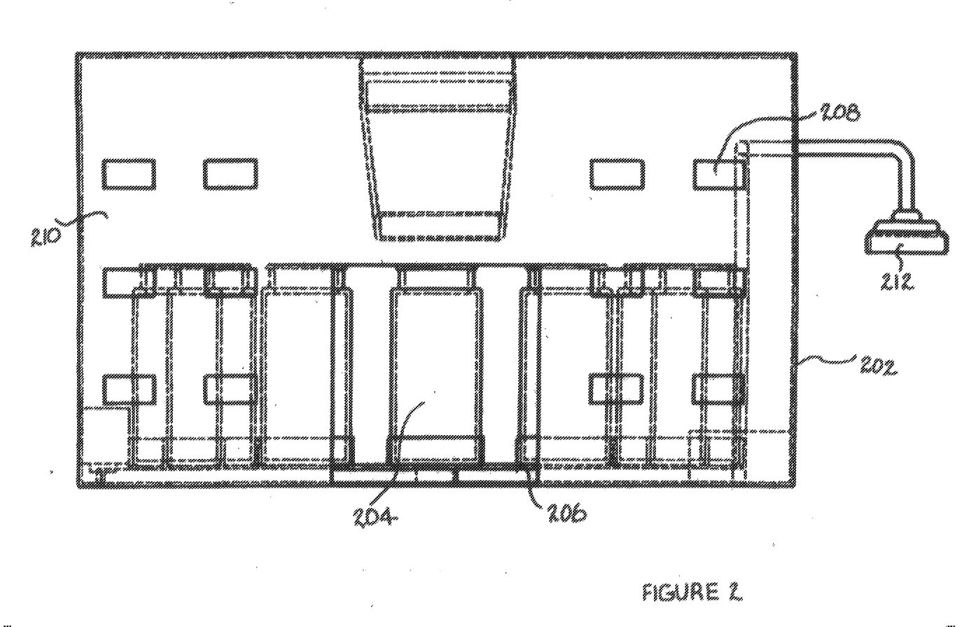

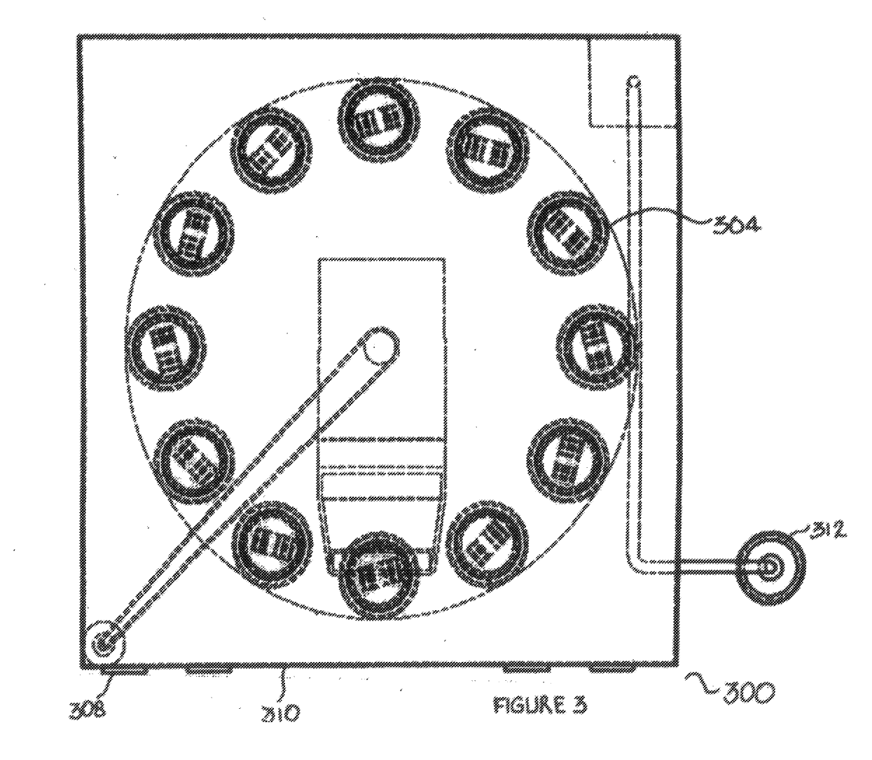

FIG. 1 illustrates an exemplary embodiment of the invention 100. A case 102 (container 1) contains a plurality of jars or other containers 104 (second containers). The second containers are placed on a transport system, such as a revolving tray (Lazy Susan) or belt system 106 that is motorized and controlled by a plurality of switches 108. Each switch controls a bar code reading and selection system that reads a barcode on each jar and moves the jar that has a matching barcode to the front of the case 110 for retrieval by the user. FIG. 2 illustrates a front view with of the dispenser 200, with case 202, second containers 204, tray 206, switches 208, front of case 210 and an external vacuum source 212. FIG. 3 illustrates a top view with of the dispenser 300, with case 302, second containers 304, tray 306, switches 308, front of case 310 and an external vacuum source 312.

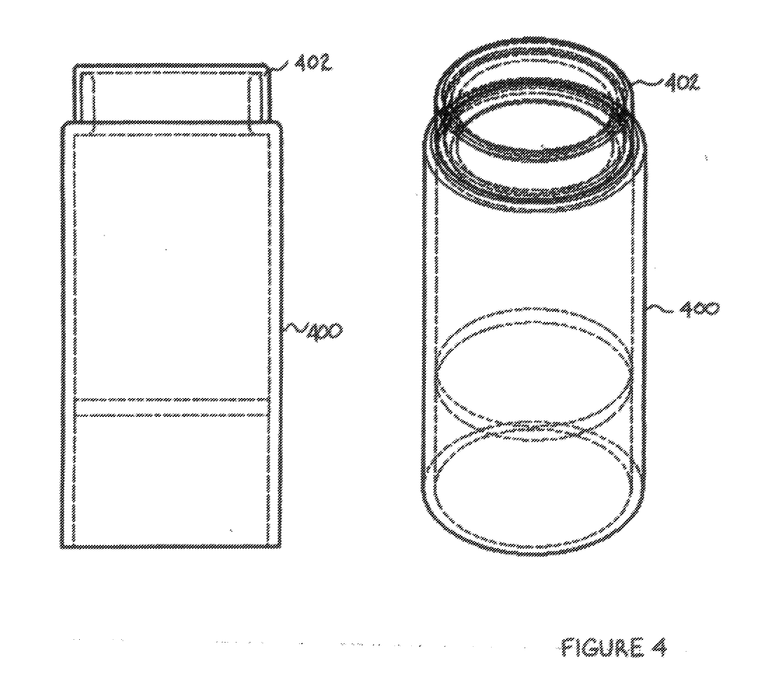

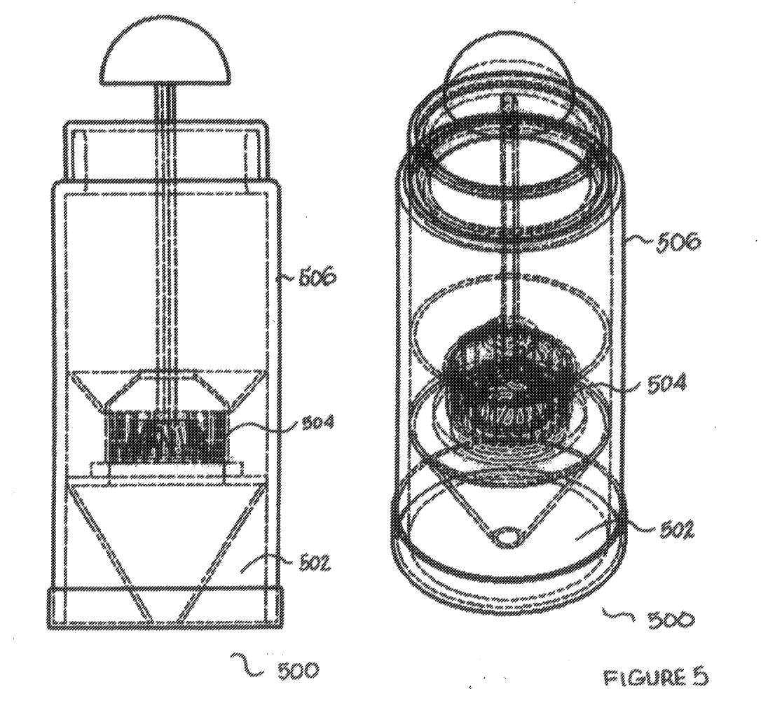

When the user has accessed the desired amount of spice, he/she may have a plurality of choices. If the second container has a piston system as illustrated in FIG. 4 and discussed below he/she may manually improve the vacuum level within the container using a piston before returning the second container to the Revolving tray (Lazy Susan).

Another embodiment of vacuum control may use an external vacuum connection 212, or 312 as illustrated in FIGS. 2 and 3.

Another embodiment of vacuum control may use an internal vacuum controls system as described above. One such embodiment comprises an internal a vacuum system and vacuum positioning system. Upon placing a spice container (second container) back into the first container the user activates a button to activate the vacuum system. This action positions the second container within the vacuum system so as to permit the vacuum system to create a vacuum within the second container. When said second container achieves a desired vacuum level, the dispensing system is able to retrieve the second container for use with the dispensing system.

At this point a vacuum system is used to vacuum seal the contents of the selected jar. Another embodiment moves the jar to an access point for removing the jar contents while within the revolving tray (Lazy Susan). The user then activates a content removal system to access the amount of spice. Then a vacuum sealing device seals the spice container.

Another embodiment of the invention discloses a vacuum sealing process that is less complex and doesn't fully vacuum seal the container, but it does a better job then if you didn't vacuum seal it at all. This embodiment as illustrated in FIG. 4 has a spice container 400 with a piston 402 moveable from the top to the bottom of the container. The rest of the container is the same as the embodiment described above. The user can fill the container with a spice and then pushes on the piston to get a vast majority of the air out (air being what causes the spice to lose its potency). The concept is much like what is done when a user puts food in a Ziplock® bag. Just before you seal the bag, you try to get as much air out of the bag before you seal it). This embodiment is a way to apply that same principle to a spice container.

As discussed above McCormick & Company supplies a spice container with a built in grinder. This product can be seen at http://www.mccormick.com/productdetail.cfin?id=6566). McCormick's grinder just grinds the spice over a dish. There is no easy way to measure the amount ground and is usually just used in small quantities. For those people that want to use ground spices in a larger quantity, they can use products like coffee grinders. However, this adds an extra appliance to wash. Also, spices tend to leave a residual taste in whatever they are ground in. This presents multiple problems. First, if the grinder is also used to grind coffee, these flavors have a tendency to mix together causing the flavor of spices to enter the flavor of the coffee and vise versa. Also, if the cook wants to grind more than one type of spice, the grinder may need to be cleaned before grinding the next spice.

The disclosed built in grinder 500 as illustrated in FIG. 5 is a cavity below a grinder 504 within a spice jar. This way, each spice can be ground within its own container, preventing problems of mixing flavors using a coffee grinder (or like grinder). On the cavity, there are measurements such as 1/4 teaspoon or 1 tablespoon etc. This allows the user to grind the amount needed precisely. The grinder as illustrated in Figure depicts a design for a spice jar which is hand powered. However, the grinder can also be incorporated into spice container design by mounting a mechanism on the outside of the container. The grinding spice jar may then be hooked up to this mechanism which would drive the grinding mechanism instead. This would allow for the spices to be ground in larger quantities and would eliminate the tedious task of hand grinding say a tablespoon of a particular spice.

The foregoing is provided for the purpose of illustrating, explaining and describing embodiments of the present invention. Further modifications and adaptations to these embodiments will be apparent to those skilled in the art and may be made without departing from the spirit of the invention or the scope of the following claims.

What is claimed is:

1. A dispensing apparatus, comprising:
a first container;
a plurality of second containers for holding various items,
a transport device with said second containers mounted on it;
a plurality of buttons on a surface of said first container with each button corresponding to each said second container within a plurality of second containers mounted on said transport device;
when one of said buttons is pushed, an appropriate second container will be moved next to an exit area of said first container and come out of said first container for access to said item within said second container;
wherein each button corresponds to a barcode on each second container representing said item within said second container; and
further wherein a scanner on an inside of said first container will scan each said barcode until it comes to the barcode that corresponds to the button pushed.

2. The apparatus of claim 1 wherein said second containers comprise jars.

3. The apparatus of claim 2 wherein said items held within said jars comprises spices.

4. The apparatus of claim 1, wherein said transport device is a rotating tray.

5. The apparatus of claim 4, wherein said rotating tray is a Lazy Susan device.

6. The apparatus of claim 1, wherein said transport device is a belt system.

7. The apparatus of claim 1, further comprising:
a vacuum system; and
a vacuum positioning system, wherein upon placing said second container into said first container and activating said vacuum system said second container is positioned on said transport device within said vacuum system said second container, and
further wherein when said second container achieves a desired vacuum level, said dispensing system is able to retrieve one of said containers.

8. The apparatus of claim 2 wherein said second containers include a vacuum piston.

9. The apparatus of claim 2 wherein said second containers include an internal grinder.

10. The apparatus of claim 9 wherein said second containers include markings for measuring usage of the contents of said containers.

11. The apparatus of claim 2 wherein said containers include a manual vacuum piston.

12. The apparatus of claim 2 wherein said containers have a vacuum sealer.

13. The apparatus of claim 13 wherein said vacuum sealer has a lid valve assembly.

14. A method storing and distributing food items comprising the acts of:
installing a plurality of second containers into a first container;
accessing a said second container from said first container;
accessing a need amount of said food item from said second container; and
returning said second container to said first container.

15. The method of claim 14 further comprising the acts of:
upon returning said second container to said first container, access a vacuum system, thus moving said second container to said vacuum system;
using said vacuum system to open said second container;
pumping an air supply within said second container, thus creating a vacuum in said second container;
removing said vacuum system from said second container; and returning said second container to a storage position.

16. A dispensing apparatus, comprising:
a first container;
a plurality of second containers for holding various items, a transport device with said second containers mounted on it;
a voice recognition system word spoken is represented by a corresponding to said second container within a plurality of second containers mounted on said transport device;
when an appropriate word is spoken, an appropriate second container will be moved next to an exit area of said first container and come out of said first container for access to said item within said second container;
wherein each word corresponds to a barcode on each second container representing said item within said second container; and
further wherein a scanner on an inside of said first container will scan each said barcode until it comes to the barcode that corresponds to the word spoken.

16. The apparatus of claim 15 wherein said second containers comprise jars.

17. The apparatus of claim 16 wherein said items held within said jars comprises spices.

18. The apparatus of claim 1, wherein said transport device is a rotating tray.

19. The apparatus of claim 4, wherein said rotating tray is a Lazy Susan device.

20. The apparatus of claim 1, wherein said transport device is a belt system.

21. The apparatus of claim 1, further comprising:
a vacuum system; and
a vacuum positioning system, wherein upon placing said second container into said first container and activating said vacuum system said second container is positioned on said transport device within said vacuum system said second container, and
further wherein when said second container achieves a desired vacuum level, said dispensing system is able to retrieve one of said containers.
